(19) United States
(12) Patent Application Publication
(10) Pub. No.: US 2015/0336266 A1
(43) Pub. Date: Nov. 26, 2015

(54) PURE TRANSLATIONAL SERIAL MANIPULATOR ROBOT HAVING THREE DEGREES OF FREEDOM WITH A REDUCED SPACE REQUIREMENT

(71) Applicant: COMMISSARIAT À L'ÉNERGIE ATOMIQUE ET AUX ÉNERGIES ALTERNATIVES, Paris (FR)

(72) Inventor: Farès Kfoury, Clamart (FR)

(73) Assignee: Commissariat à l'ènergie atomique et aux ènergies alternatives, PARIS (FR)

(21) Appl. No.: 14/759,072

(22) PCT Filed: Jan. 8, 2014
(86) PCT No.: PCT/EP2014/050194

§ 371 Date: Jul. 2, 2015

(30) Foreign Application Priority Data
Jan. 8, 2013 (FR) 1350127

(51) Int. Cl. B25J 9/10; B25J 17/00; B25J 9/04; B25J 18/00

(52) U.S. Cl. CPC B25J 9/1065; B25J 18/00; B25J 17/00; B25J 9/04

(57) ABSTRACT

A serial carrier having at least three degrees of freedom, comprising three rotoid connections, two of which have orthogonal axes (X1, X2), one among the first, second and third connections enabling the carrier to be hinged to a frame, and comprising an effector (8), said carrier comprising two passive devices (4, 6) with a parallelogram deformable in the plane which are connected on the one hand to the frame and on the other hand to the effector (8), and a first and a second passive transmitting devices (D1, D2) each formed by a double U-joint, the first double U-joint (D1) being connected to the frame and the second double U-joint being connected to the effector, both double U-joints being connected between them. The deformable parallelogram devices (4, 6) and the transmitting devices (D1, D2) can restrict the movement of the effector (8) to the only three translational degrees of freedom.

### TECHNICAL FIELD AND PRIOR ART

The present invention relates to a manipulator robot or carrier having three degrees of freedom with a reduced space requirement.

Manipulator robots are used at a large scale in industry, to perform among other things tasks that can be repetitive, laborious or demanding a high repeatability level. One of the most common tasks of a robot is to position and/or orient any solid in space. For this task, several criteria can be competing in defining the architecture of a manipulator such as maximum space, footprint, loading capacity, etc.

The structure of a manipulator robot is generally formed by two parts. A first part comprises first axes starting from the frame, used for positioning the manipulated load and which makes up the so-called “carrier”, and a second part carrying the last axes, used for orienting the load and which makes up “the wrist join”.

There are two types of carriers, parallel architecture carriers and serial architecture carriers.

Parallel architecture carriers comprise a frame, several identical branches connected to the frame, the branches being comprised of serial robots the connections of which are prismatic, rotoid, . . . , connections, being motorized or not, and a platform making up the robot effector, platform to which the terminations of all the branches are connected. These carriers have a high footprint in comparison with the maximum working space.

Serial architecture carriers are formed by serial mechanical connections. Further, in order to position any object in space, they are provided with at least three connections to cover the three translational degrees of freedom. This can be in the order, three rotoid connections, three prismatic connections, two rotoid connections and a prismatic connection or one rotoid connection and two prismatic connections.

These have the advantage of offering the largest reachable space at a given footprint.

When a carrier comprises rotoid connections, each of them induces a rotation on the load upon positioning it, i.e. each displacement of the load by a rotoid connection is comprised of a translational movement and a rotational movement. But, in some cases, it is preferable that the carrier moves the load in translation only, in order, for example, to uncouple positioning and orienting, that is the axes of the carrier and those of the wrist join.

Carriers in which the induced rotations are removed are being developed.

For example, the KUKA company makes a serial carrier having three degrees of freedom with an architecture with three rotoid connections. This carrier is for example described in document Innovation in the Flexibility of Food Packaging Machinery, Dena Mullen, Feb. 10, 2006, Clemson University. In order to remove rotations induced by the rotoid connections, a further device consisting of reaction bars and a corner plate has been added. This device, being passive and with a small space requirement, has the function of holding the robot effector in a horizontal position. Thus, rotations induced by rotoid connections having horizontal axes are removed. To compensate for the rotation induced by the rotoid connection having the vertical axis, further means formed by a motorized vertical axis of rotation have been added at the effector. Consequently, this robot is relatively complex because of its manufacture, and because of its operation due to the motorized further means.

Further, the motorized further means at the effector form a load on-board the robot, ascribable to the total loading capacity thereof.

### DISCLOSURE OF THE INVENTION

Consequently, one purpose of the present invention is to provide a serial carrier having at least three degrees of freedom, wherein the effector orientation is made independent of its positioning in a relatively simple manner, passively, that is without further motorization and with a small space requirement, i. e. the impact of which on the reachable space is substantially reduced.

The previously set forth purpose is achieved by a serial carrier having at least three degrees of freedom comprising a frame, arm members hinged to each other, an arm member being mounted hinged to the frame and an effector carried by one of the arm members, and at least three connections between the arm members and the frame, at least two of the three connections being rotoid connections with orthogonal axes and the other being a rotoid connection or a prismatic connection, said carrier comprising at least one first device forming a deformable parallelogram and a passive device for transmitting the orientation of the carrier frame to the carrier effector, said passive transmitting device comprising two connections each having at least two intersecting axes of rotation.

In other words, a carrier is made comprising at least one deformable parallelogram device and an orientation transmitting device, forming passive means securing the orientation of the effector to that of the carrier base.

The passive means can be used otherwise, for example for offsetting to the robot base the actuation of either rotations at the wrist join, offering the advantage of obtaining an actuation of these rotations which is uncoupled from the carrier axes used for positioning the load.

Particularly advantageously, the orientation transmitting passive device is formed by a double U-joint. It is of a very simple and very robust structure.

Also particularly advantageously, the carrier has three rotoid connections. It thus offers a reachable space very significant with respect to its footprint.

In a preferred exemplary embodiment, the third connection is a rotoid connection having an axis parallel to one of both first connections, the two rotoid connections having a parallel axis being consecutive, and the robot comprises two planar deformable parallelogram devices and two passive transmitting devices.

The passive transmitting devices according to the invention also offer the advantage of being adaptable to different carrier architectures. Adding them does not increase the degree of hyperstatics of the initial carrier. Further, they are not motorized, they do not result in an increasing complexity of the systems for controlling and electrically supplying the carrier.

Further, they have a reduced space requirement, and follow the carrier morphology so as to have the smallest impact possible on the initial reachable space of the carrier.

Accordingly, the subject-matter of the present invention is a serial carrier having at least three degrees of freedom, comprising a first and a second rotoid connections having orthogonal axes and at least one third rotoid or prismatic connection, one among the first, second and third connections enabling the carrier to be hinged to a frame, and comprising an effector, said carrier comprising at least one passive device with a parallelogram deformable in the plane connected on the one hand to the frame and on the other hand to the effector, and at least one passive transmitting device, called a transmitting device, comprising a first, a second and a third elements, the first element being connected to the frame and having a fixed orientation with respect to the frame, the third element being connected to the effector and having a fixed orientation with respect to the effector, and the second element being hinged to the first element and to the third element by two connections each comprising at least two intersecting axes of rotation, said at least one deformable parallelogram device and said at least one transmitting device being able to restrict the movement of the effector to the only three translational degrees of freedom.

In an exemplary embodiment, the deformable parallelogram passive device is a corner plate device comprising an arm and a reaction bar which are parallel and connected by two connecting rods by pivot connections, one of the connecting rods having the shape of a corner plate to which the second element is hinged.

In another exemplary embodiment, the deformable parallelogram passive device is a cable link device.

In one embodiment, the transmitting device can be of a fixed length and form a parallelogram deformable in space with an arm of the deformable parallelogram passive device. At least one of the connections, that comprises said at least one transmitting device, can then connect the second element to the first element and to the third element is a ball-joint connection.

In another embodiment, the transmitting device is a double U-joint. Advantageously, the double U-joint has a variable length.

The third connection can be a rotoid connection having an axis parallel to that of one of both other connections, comprising a second deformable parallelogram device in the plane, provided between the first deformable parallelogram device and the effector.

The second parallelogram device deformable in the plane can be a corner plate system the corner plate of which is common to the first corner plate device, the second corner plate device connecting the first corner plate device to the effector, the first and second corner plate devices being hinged to the corner plate, said carrier also comprising a second transmitting device connecting the first transmitting device to the effector, both transmitting devices being connected by an element hinged by a pivot connection with respect to said corner plate.

The second transmitting device is for example a double U-joint.

The third connection can be a prismatic connection, the planar deformable parallelogram device being a cable and tackle block device.

### BRIEF DESCRIPTION OF THE DRAWINGS

The present invention will be better understood using the description that follows and the figures on which:

FIG. 1 is a perspective view of an exemplary embodiment of a carrier having three rotoid connections according to the invention,

FIG. 2 is a schematic representation of a double U-joint,

FIG. 3 is a side view of an alternative of the carrier of FIG. 1 having a degree 2 of hyperstatics,

FIGS. 3A and 3B are partial views of the carrier of FIG. 3 on which a parallelogram deformable in space formed by the transmitting device D1 and the segment 10 is represented,

FIG. 4 is a top view of the carrier of FIG. 3 in two end positions,

FIGS. 5A and 5B are partial perspective views of a carrier according to another exemplary embodiment implementing ball-joint connections in two different positions, (FIG. 5B shows in particular the effect generated by replacing U-joints by ball-joints),

FIG. 6 is a perspective view of another exemplary embodiment of a carrier with three rotoid connections,

FIG. 7 is a perspective view of another exemplary embodiment of a carrier having three rotoid connections according to the invention,

FIG. 8 is a perspective view of an exemplary embodiment of a carrier having two consecutive rotoid connections and one prismatic connection according to the invention,

FIG. 9 is a perspective view of an exemplary embodiment of a carrier having two non-consecutive rotoid connections and one prismatic connection according to the invention,

FIG. 10 is a perspective view of an exemplary planar deformable parallelogram device, formed by a cable link,

FIGS. 11A to 11D are detail perspective views of the structure of the carrier of FIG. 1.

### DETAILED DISCLOSURE OF PARTICULAR EMBODIMENTS

The present invention relates to a carrier comprising at least three connections, at least two of which are rotoid connections having orthogonal axes X1 and X2 and the third of which is a rotoid connection having an axis X4 or a prismatic connection having an axis Y1. The axes X1, X2 and X4 are used throughout the description to designate the axes of the rotoid connections of the carrier, the axis X1 being orthogonal to the environment to which the carrier is attached, for example the ground or a wall, and the axes X2 and X4 are orthogonal to the axis X1. The same references are used in the description of different examples and embodiments to designate elements having the same functions.

The terms “horizontal” and “vertical” are considered with respect to the representation of the figures on the drawings and are in no way limiting. Indeed, a carrier the frame of which is attached to a tilted ground and the axes of the rotoid connections of which are thus neither vertical, nor horizontal, does not depart from the scope of the present invention. Further, the carrier can be tilted with respect to the ground or the wall to which it is attached.

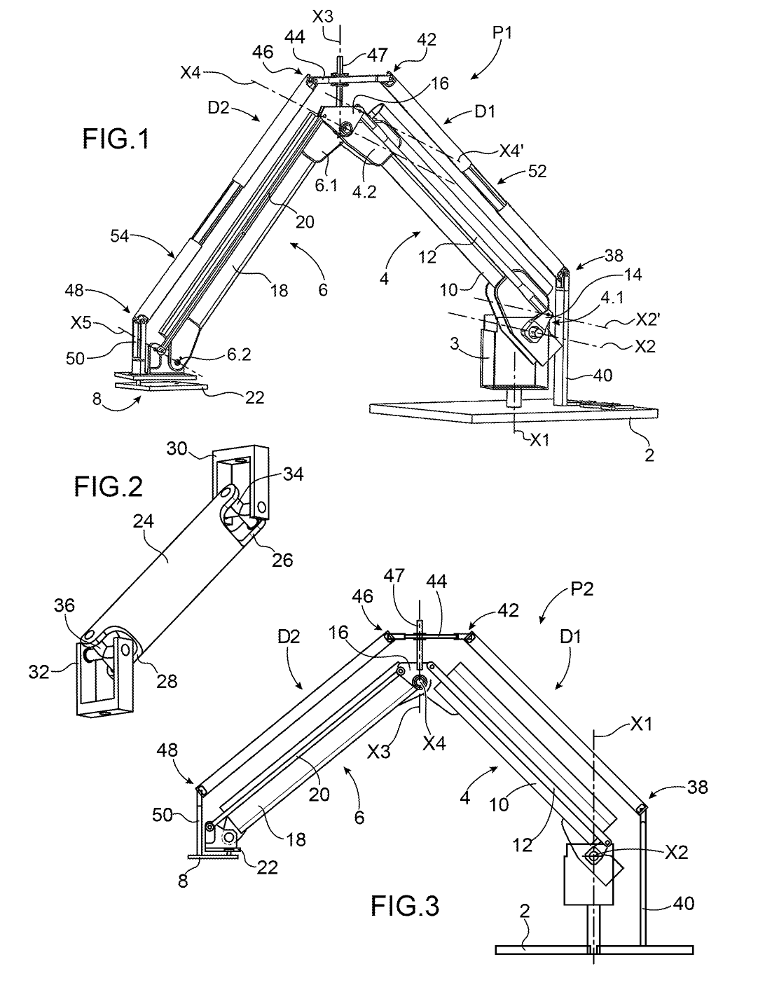

In FIG. 1, a particularly advantageous exemplary embodiment can be seen of a serial carrier P1 having three rotoid connections comprising a frame 2, intended to be fixed. In the example represented, it is attached to the ground. The carrier comprises several elements hinged to each other and hinged to the frame 2.

The carrier P1 comprises a clevis 3 mounted rotatably hinged to the frame 2 about the vertical axis X1 forming the first rotoid connection, a first hinged assembly 4 with a deformable parallelogram, mounted rotatably hinged to the clevis 3 about the horizontal axis X2 by a first longitudinal end 4.1 forming the second rotoid connection, a second hinged assembly 6 with a deformable parallelogram mounted rotatably hinged about the axis X4 by a first longitudinal end 6.1 to a second longitudinal end 4.2 of the first hinged assembly forming the second rotoid connection, and an effector 8. The axis X4 is parallel to the axis X2 in this exemplary embodiment.

The effector 8 is for example a device able to carry a load or a tool.

The hinged assemblies 4 and 6 have a deformable parallelogram structure which is well known to those skilled in the art, and they will be briefly described.

The hinged assembly 4 comprises a carrying arm 10 and a reaction arm 12 which are mounted parallel to each other.

The carrying arm 10 is hinged to the clevis 3 about the axis X2, and a connecting rod 14 is hinged to the carrying arm 10 about the axis X2 and is rotatably hinged about an axis X2′ parallel to X2 onto the reaction arm 12. The connecting rod 14 has a fixed orientation with respect to the clevis 3, which imposes the orientation of the corner plate 16 about X4. As a variant, it can be contemplated to actuate the connecting rod 14 about X2, which enables the actuation of either of the rotations at the wrist join to be transferred to the robot base, offering the advantage of obtaining an actuation of these rotations which is uncoupled from the carrier axes used for positioning the load.

The carrying arm 10 is hinged at its other longitudinal end about the axis X4 to a corner plate 16 and the reaction arm 12 is also hinged to the corner plate 16 about an axis X4′ parallel to the axis X4.

The carrying arm 10, reaction arm 12, connecting rod 14 and corner plate 16 assembly forms a planar expanding parallelogram, contained in a substantially vertical plane.

The second hinged assembly 6 comprises a boom arm 18 and a reaction arm 20 which are parallel to each other and hinged by a first end to the corner plate 16 respectively about the axis X4 and an axis X4″ parallel to the axis X4, and by a second end to a plate-forming connecting rod 22 respectively about the axis X5 and an axis X5′ parallel to the axis X5. The corner plate 16 is common to both hinged assemblies 4, 6.

The effector 8 is in a pivot connection about an axis parallel to the axis X1 with the plate 22.

Both hinged assemblies move the plate 22 and the effector 8 in space while holding it in a horizontal orientation. The plate 22 and the effector 8 thus keep a horizontal orientation irrespective of their displacements in the different space directions.

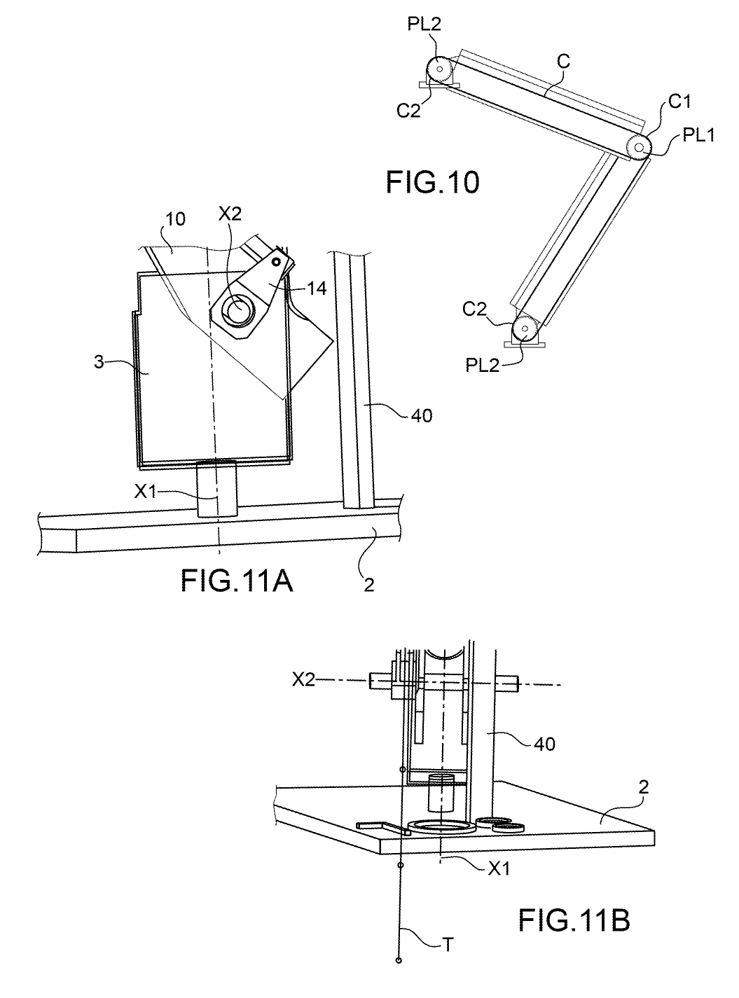

The hinged assembly(ies) having a deformable parallelogram could be replaced by one or more cable parallelogram devices as represented in FIG. 10 in two positions. For example, the case where the cable parallelogram device replaces the hinged assembly 4 will be considered, the pulley P1 represents the connecting rod 14: its center is carried by the axis X2, and it is fixed with respect to the clevis 3. The pulley P2 is embedded in the corner plate 16. Its center is carried by the axis X4 and it is in the same plane as the pulley P1. Finally, a cable link C is wound about both pulleys, and a cable point Cl is crimped to the pulley P1, and a second cable point P2 is crimped to the pulley P2. Thus, the orientations of both pulleys P1, P2 about the axes X2 and X4 are found coupled. Alternatively, the pulley P21 can replace the corner plate 16 ; in this case the assembly 6 is also formed by a cable parallelogram. To that end, the pulley 16 is a double-grooved pulley to form one of the pulleys of the cable parallelogram replacing the deformable parallelogram 6.

The carrier also comprises first and second devices D1 and D2 for transmitting the orientation of the frame 2 to the effector 8.

The first D1 and second D2 devices for transmitting the orientation from the frame to the effector are formed by double U-joints. For the sake of simplicity, the devices D1 and D2 are designated in the following by transmitting device D1 and transmitting device D2.

A double U-joint is schematically represented in FIG. 2, and comprises a center arm member 24 having a longitudinal axis provided at both ends thereof with a fork 26, 28 and two other forks 30, 32 respectively connected to the forks 26, 28 by a cross piece 34, 36 carrying four axes perpendicular to each other.

Generally, the forks 26, 28 are carried at the end of an input shaft and at the end of an output shaft. The double U-joint enables a rotational transmission to be achieved between any input shaft and any output shaft. If the forks 26 and 28 are coplanar, and if the output axis is parallel to the input axis, the U-joint is then called a “constant-velocity joint”, and the rotation speeds of the input and output shafts are accurately equal.

In the example represented, a rod 40 is attached to the frame, the first end 38 of the transmitting device D1 is connected to the rod 40 and has a fixed orientation with respect to the rod.

The transmitting device D1 comprises a second end 42 connected to, and has a fixed orientation with respect to a bar 44 which is rotatably hinged to the corner plate 16 about an axis X3 parallel to the axis X1. The bar 44 is rotatably mounted to a rod 47 secured to the corner plate 16.

The transmitting device D2 comprises a first end 46 connected to the bar 44 and has a fixed orientation with respect to the same. The transmitting device D2 comprises a second end 48 connected to the effector 8 and has a fixed orientation with respect to the same. In the example represented, a rod 50 is attached to the effector 8; the second end of the transmitting device D2 is embedded on the rod 50.

The connections between the second end 42 of the transmitting device D1 and the bar 44, between the first end 46 of the transmitting device D2 and the bar 44, between the second end 48 of the transmitting device D2 and the effector 8 are either sliders, or inserts, all the connections not being necessarily of the same type.

The rod 50 passes through the plate 22 and is in a pivot connection with an axis X7 parallel to the axis X1 with the plate, such that the effector is in pivot connection with the plate. The plate can be pierced to accommodate a bearing therein, which will ensure the pivot connection between the effector and the plate.

In the example represented and particularly advantageously, the transmitting devices comprise a slide link 52, 54 at their center arm member such that the center arm member is of a variable length. The transmitting devices D1 and D2 transmit the vertical axis orientation to the effector through the bar 44 and the rod 50.

This embodiment with transmitting devices having a variable length enables an overall isostatic assembly to be obtained. Consequently, it offers the advantage of having a great freedom in making the carrier, more particularly in the arrangement of the axes.

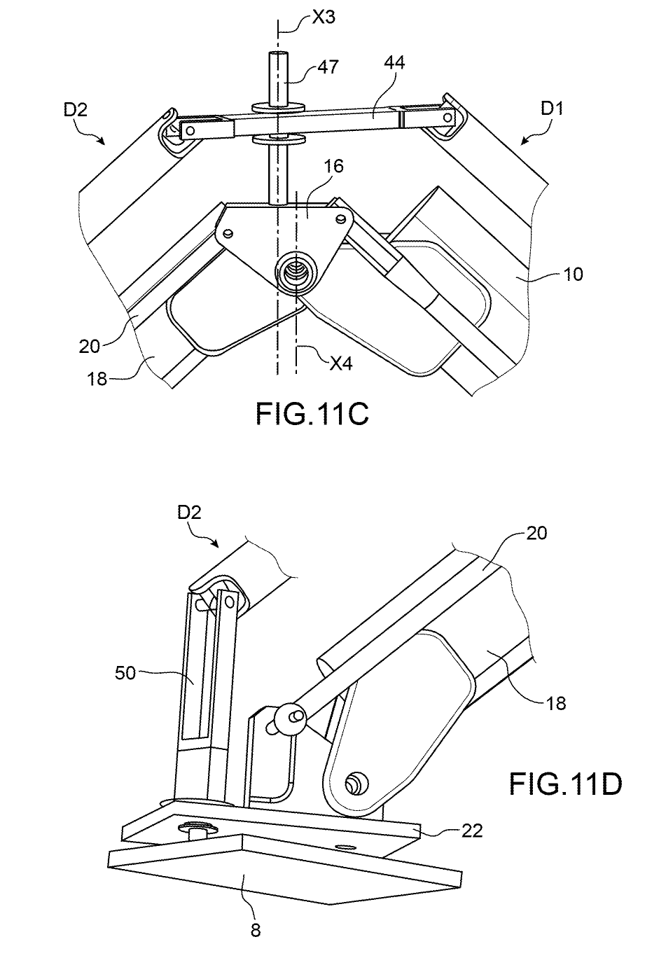

Indeed, the carrier can be such that the axes X1 and X2 are not concurrent as is represented in FIG. 11A.

The hinged assemblies can also be made such that the reaction arms define a plane T not containing the axis X1, as is represented in FIG. 11B.

The axis of the pivot connection between the bar 44 and the rod 47 integral with the corner plate may not be intersecting with the axis X4, as is represented in FIG. 11C. Further, the axis of the pivot connection between the plate 22 and the effector 8 can have any position with respect to the plate 22, as is represented in FIG. 11D.

The fixed position of the rod 40 with respect to the ground can be any position.

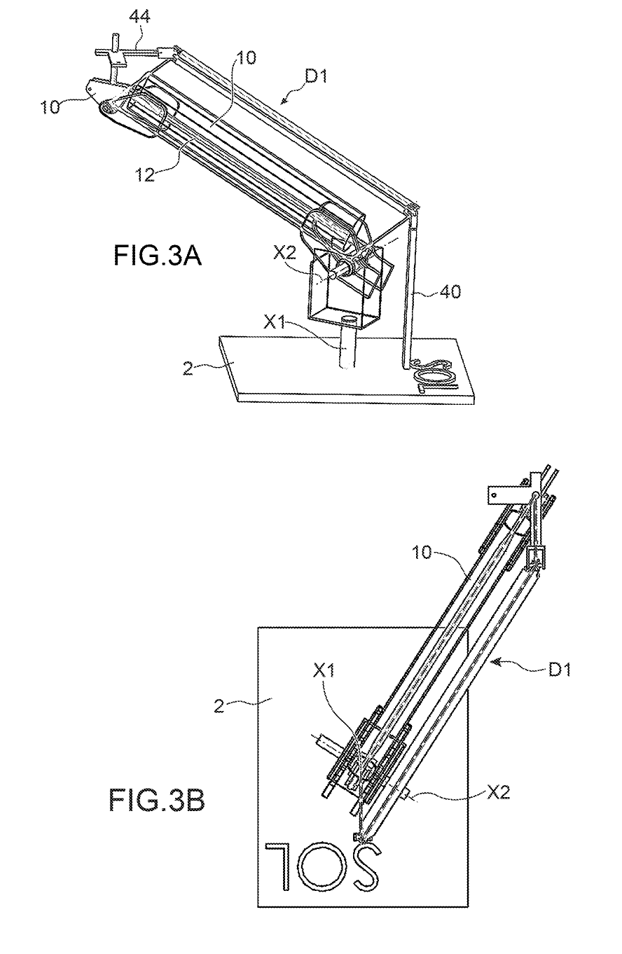

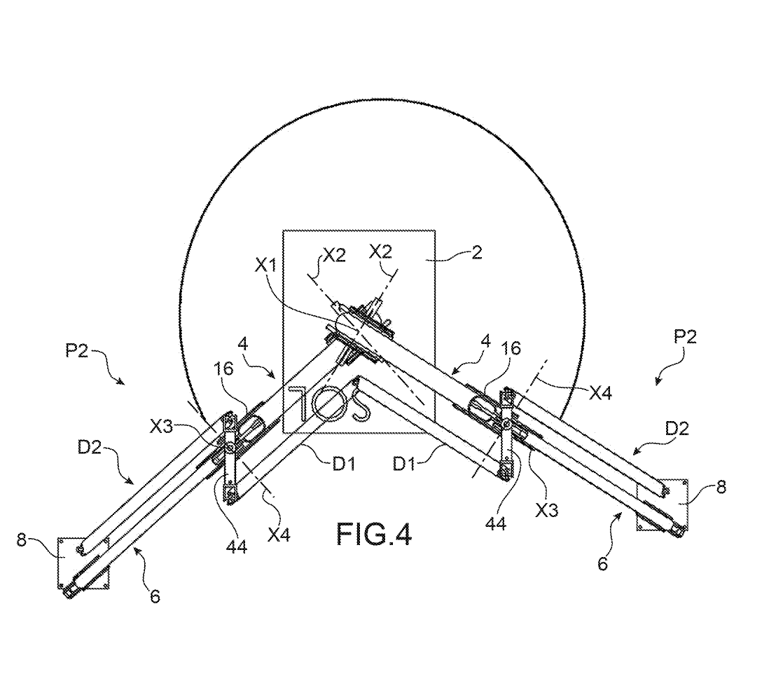

In an alternative embodiment P2 of the carrier of FIG. 1 represented in FIGS. 3 and 4, which offers the advantage of a simplified manufacture, the transmitting devices are of a fixed length. In this exemplary embodiment, the carrier is such that the axes X1 and X2 are concurrent; the hinged assemblies are such that the reaction arms 12, 20 define a plane containing the axis X1. The axis of the pivot connection between the bar 44 and the rod 47 integral with the corner plate is intersecting with the axis X4 of the rotoid connection. Further, the axis of the pivot connection between the plate 22 and the effector 8 is in the plane defined by the reaction arms which contains the axis X1 and further is intersecting with the axis of rotation between the boom arm 18 and the plate 22 and the rod 40 has a length and a ground position such that the carrying arm 10 and the center element of the device D1 form a parallelogram.

The transmitting devices D1 and D2 then form, together with the segments 10 and 18 of the carrier, parallelograms deformable in space. The parallelogram is expanded by rotation about one of its sides and/or by a modification of its angles. The expanding parallelograms are represented in doted lines in FIGS. 3A and 3B.

A carrier which would differ from that of FIGS. 3 and 4 in that the axis of the pivot connection between the plate 22 and the effector 8 would have any position with respect to the plate 22 can be contemplated. In this case, only one of the transmitting devices, the second one could comprise a slide link.

A carrier which would differ from that of FIGS. 3 and 4 in that the fixed position of the rod 40 would be any position with respect to the ground can also be contemplated.

In this case also, only one of the transmitting devices, the first one, could comprise a slide link.

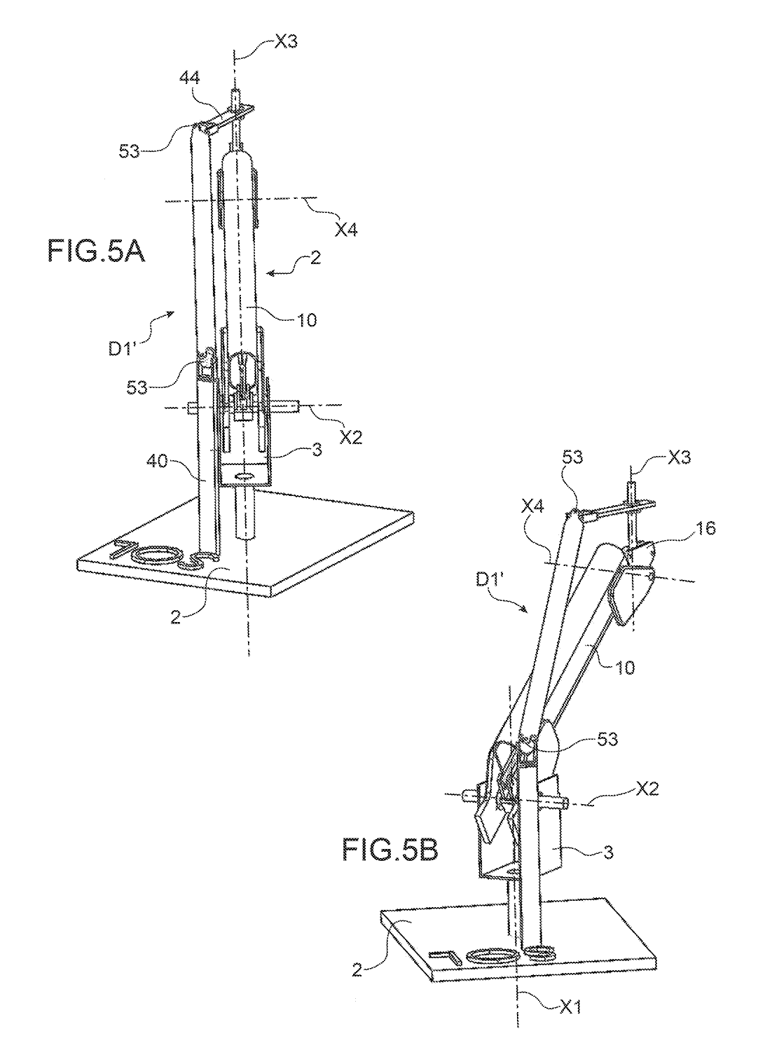

In FIGS. 5A and 5B, a carrier having the structure of the carrier of FIGS. 3 and 4 can be seen partially represented, but comprising transmitting devices D1′, D2′ wherein at least one of the cross pieces of the U-joint is replaced by a ball-joint connection. This carrier has however singular positions, and its reachable space is found dramatically limited with respect to the carrier comprising double U-joint. In the present invention, in the case where handling and displacing the load are ensured by the carrier and removing a vertical axis induced rotation is ensured by the devices D1, D2. The transmitting devices D1 and D2 thus do not see the load and can have relatively low dimensions with respect to the other segments of the carrier.

It will be understood that the shape of the elements 40, 44 and 50 is not limiting and any other shape can be suitable.

Thanks to the invention, the horizontal orientation of the effector is held regardless of its displacement in space by controlling the first and second hinged assemblies by virtue of the planar deformable parallelogram devices, and the vertical axis orientation is held thanks to the transmitting devices D1 and D2.

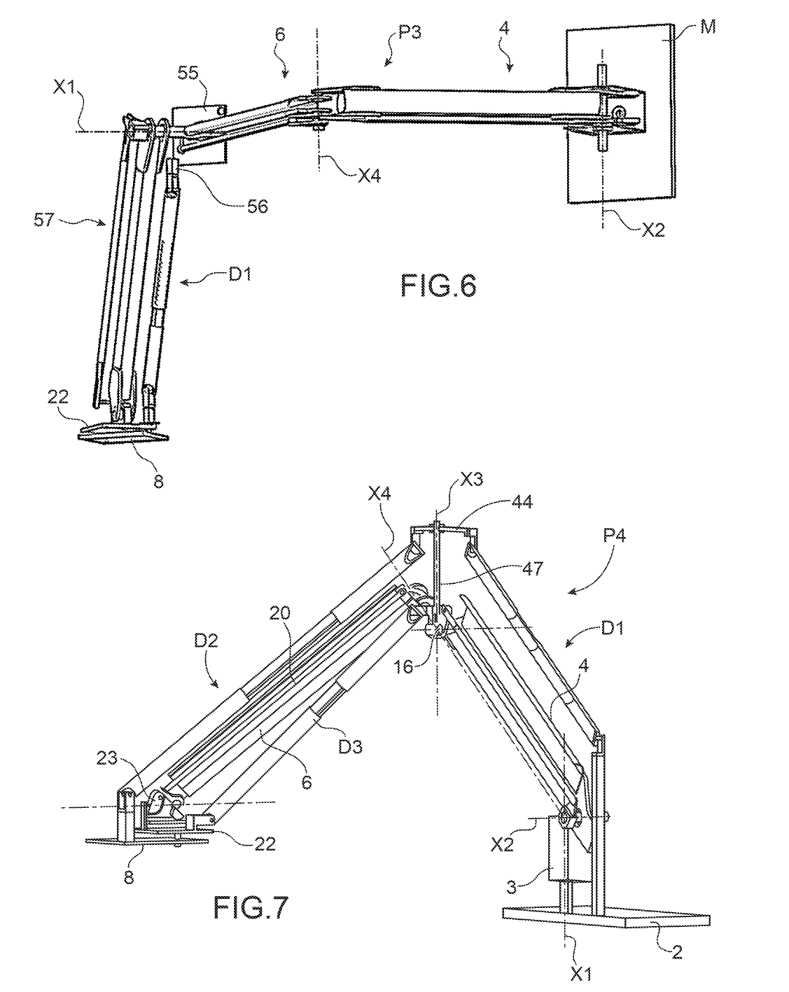

In FIG. 6, another exemplary embodiment of the carrier P3 with three rotoid connections can be seen.

The carrier comprises two rotoid connections having parallel axes X2 and X4 and a rotoid connection having an axis X1 orthogonal to X2 and X4. Both rotoid connections with the axes X2 and X4 generate induced rotations with axes parallel to the axis X2 (and to the axis X4) and the rotoid connection having the axis X1 generates an induced rotation about the axis X1.

In this example, the carrier is attached to a vertical wall M, for example a wall. The carrier comprises a frame embedded in the wall M, two hinged assemblies 4, 6, a first assembly 4 hinged to the frame 2 about the axis X2 and a second assembly 6 hinged to the first element hinged about the axis X4. The first 4 and second 6 hinged assemblies enable the induced rotations, with axes parallel to the axis X2, to be removed.

The carrier comprises a third deformable parallelogram assembly 57 hinged to the second hinged assembly 6 about the axis X1, and a transmitting device D1 for transmitting the orientation from the wall to the effector. The axis X1 is carried by the second segment of the robot; it remains horizontal but not necessarily perpendicular to the wall.

For this, a plate 55 is hinged about an axis X5 parallel to X4, at the second end of the second hinged assembly 6 and to which a rod 56 is attached. The plate 55 has a fixed orientation with respect to the frame 2 attached to the wall thanks to the two hinged assemblies 4 and 6. The transmitting device D1 connects the rod 56 to the effector 8 which is in a pivot connection with an axis parallel to X4 with the plate 22 of the third hinged assembly 57.

The transmitting device enables the rotoid connection with the axis X1 to be spanned, the induced rotation of which with the axis X1 is removed by the hinged assembly 57. The effector preserves a fixed orientation with respect to the plate 55 and thus with respect to the frame 2 thanks to the transmitting device D1.

As has been mentioned for the preceding example, the transmitting device comprises a slide link so as to have a variable length, thus making the assembly isostatic. It is however possible using a particular arrangement of the hinges of the device D1, to form a parallelogram deformable in the space between the same and the hinged assembly 57. In this case, the slide link of the device D1 can be removed with a functional hyperstatic assembly.

As has been mentioned for the previous example, at least one of the U-joint of the device D1 can be replaced by a ball-joint connection. The reachable space of the robot is found dramatically reduced because of a singular position introduced by the ball-joint connection.

In FIG. 7, another example of a carrier P4 having three rotoid connections with orthogonal axes can further be seen.

This carrier differs from that of FIG. 1 in that the axes of three rotoid connections are orthogonal. The carrier comprises two hinged assemblies 4, 6, the second hinged assembly 6 being hinged to the first hinged assembly 4 about the axis X4.

The carrier implements a transmitting device D1 connecting the rod 40 to the bar 44, a second transmitting device D2 connecting the bar 44 to the effector 8, both these transmitting devices D1, D2 ensuring transmission of the orientation having a vertical axis; and a third transmitting device D3 between the corner plate 16 and a plate 22 rotatably hinged about an axis parallel to the axis X2 onto the connecting rod 23 of the second hinged assembly. The effector 8 is hinged to the plate 22 about an axis parallel to the axis X1. This third transmitting device D3 ensures transmission of the orientation having a horizontal axis parallel to X2 to the plate 22, which is imposed to the effector.

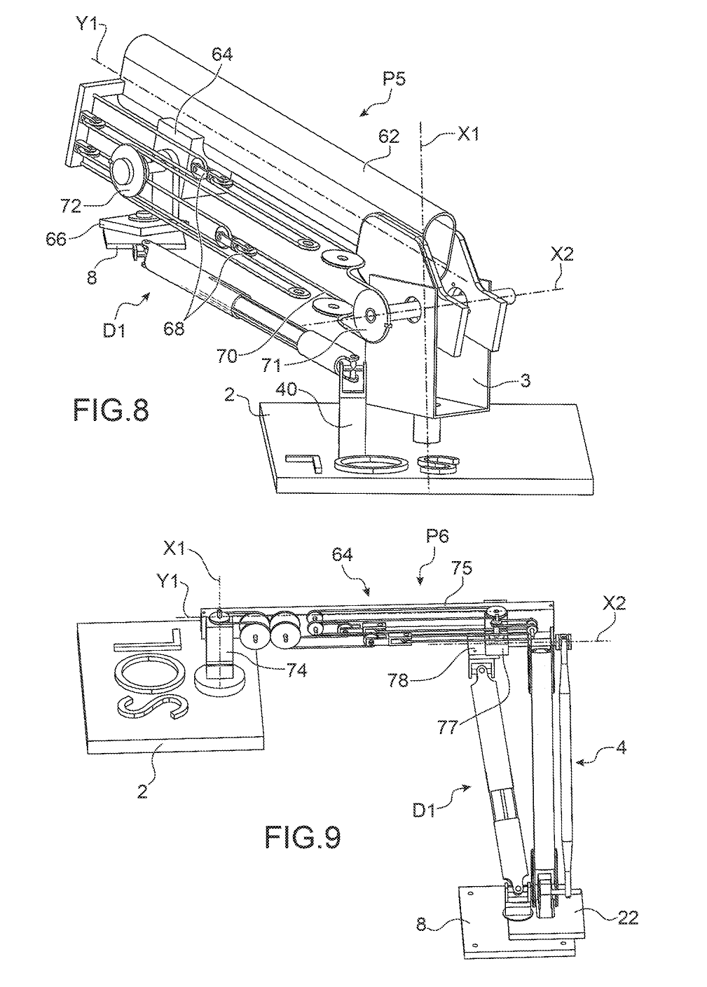

In FIG. 8, another exemplary embodiment of the carrier P5 having two consecutive rotoid connections having orthogonal axes and a prismatic connection can be seen.

The rotoid connections have axes designated X1 and X2 and the prismatic connection has an axis designated Y1.

The carrier P5 comprises a frame 2 on which is mounted a clevis 3 rotatably hinged about the axis X1, and a carrying arm 62 rotatably hinged in the clevis 3 about the axis X2 and a carriage 64 able to slide on the carrying arm 62 along the axis Y1.

A plate 66 is rotatably hinged about an axis parallel to X2 to the carriage 64 and the effector 8 is rotatably hinged to the plate.

A cable and tackle block system 67 known to those skilled in the art connects the axis X2 to the plate 66 such that the plate 66 remains horizontal in the example represented. The cable and tackle block system is partially represented in FIG. 8 for the sake of clarity.

The cable and tackle block system is well known to those skilled in the art and its operation will be briefly described. This is used to remove a rotation the axis of which is perpendicular to the axis of a slide link to be spanned.

When the carriage 64 is translated with respect to the carrying arm 62, both tackle blocks 68 are moved in the same direction and with the same value along the axis Y1, and hold the cable 70 tensioned. When all of this rotate about the axis X2, the tackle blocks 68 remain stationary with respect to the carrying arm 62, and the cable 70, attached to a pulley 72 connected to the plate 66 on the one hand and to the pulley 71 connected to the clevis 3 on the other hand, enables the induced rotation on the plate 66 to be removed.

A transmitting device D1 with double U-joint is provided between the frame 2 and the effector 8 so as to hold the orientation with an axis parallel to the axis X1 of the effector 8 with respect to the frame 2. The transmitting device also comprises a slide link making the carrier isostatic.

According to another exemplary embodiment not represented, a carrier can be made comprising in the order, from the frame, a prismatic connection, and two rotoid connections having orthogonal axes, wherein the effector orientation is connected to that of the frame. For example, such a carrier can be made starting from the carrier architecture of FIG. 6, and by modifying it so as to replace the pivot connection with the axis X2 connecting the robot to the frame with a slide link with an axis X2. The reaction bar of the hinged assembly 4 can be removed, and the corner plate 16 can thus be embedded in the carrying arm 10.

In FIG. 9, another exemplary carrier P6 having two rotoid connections with orthogonal axes and a prismatic connection can be seen, wherein both rotoid connections are not consecutive.

The carrier comprises a frame 2 attached to the ground, a shaft 74 rotatably movable with respect to the frame about an axis X1, a carrying arm 75 fixed on the shaft 74 along which a carriage 77 is slideable along the axis Y1, a parallelogram hinged assembly 4 hingedly mounted to the carriage 77 about the axis X2.

A cable and tackle block system 67 to span the slide ling enables the rotation induced by the rotoid connection with the axis X1 to be removed, and thus the orientation of the plate 78 to be connected with that of the frame, the plate 78 being in a pivot connection with an axis parallel to X1 with the carriage 77. The hinged assembly 2 enables the induced rotation of the rotoid connection with the axis X2 to be removed and thus the orientation of the plate 22 to be held horizontal, this being in a pivot connection with an axis parallel to X2 with respect to the carrying arm 10 of the hinged assembly 4.

A transmitting device D1 with double U-joints connects the orientation of the effector 8 to that of the plate 78, the latter being, as in the example of FIG. 1, in a pivot connection with an axis parallel to X1 with the plate 22.

The orientation of the effector is thus connected to that of the frame.

In the example represented, the transmitting device also comprises a slide link making the assembly isostatic.

In all the examples described, the transmitting devices with double U-joints can comprise a slide link so as to have a variable length and enable isostatic structures to be made.

In all the examples described, the U-joint connections of the transmitting devices, the length of which is fixed, can be replaced by ball-joint connections, by means of a particular arrangement of the hinges of these devices, such that they form with the corresponding hinged assemblies, parallelograms deformable in space.

In the example represented, the transmission of the fixed orientation of the frame to the effector has been described. The orientation of the latter is thus constant regardless of its displacements in space. A modification of this orientation can be contemplated by providing a device connected to one of the double U-joints and to the frame or to an intermediate element having the frame orientation, able to displace the double U-joints and act on the orientation of the effector. Thus, the control of the effector orientation is offset to the frame or at the intermediate element and is not onboard at the effector.

By taking the example of the carriers P2, P4 and P5 (FIGS. 3, 7 and 8), the actuation of the rotation with a vertical axis is made by actuating the rod 40 rotating about the axis X1 with respect to the frame, for example on a turn table. On the carrier P3 of FIG. 6, it is possible to actuate the connecting rod of the hinged assembly 4 rotating about the axis X2. As regards the carrier P6 of FIG. 9, the orientation holding cable can be replaced by a toothed belt, which will allow the plate 78 and the effector 8 to be rotatably actuated with a vertical axis.

By virtue of the invention, the series carriers form pure translational positioners.

The means implemented by the invention have the advantage of being passive ones, in embodiments, they involve neither motorized means and in other embodiments, the motorized means are upstream of the transmitting devices, nor to be controlled, they do not increase the degree of hyperstatics of the initial carrier. They provide the function of removing induced rotations, which is separated from the load handling function ensured by the carrier itself.

Depending on the configuration, they can be biased by relatively low strains, and their dimensions can then be reduced with respect to the initial carrier.

Further, these means can be readily integrated to existing carriers, they are relatively discreet and with a small space requirement and follow the carrier morphology such that they have a very low impact on the reachable space of the initial carrier.

What is claimed is:

1. A serial carrier having at least three degrees of freedom, comprising a first and a second rotoid connections having orthogonal axes and at least one third rotoid or prismatic connection, one among the first, second and third connections enabling the carrier to be hinged to a frame, and comprising an effector, said serial carrier comprising at least one passive device with a parallelogram deformable in the plane connected on the one hand to the frame and on the other hand to the effector, and at least one passive transmitting device comprising a first, a second and a third elements, the first element being connected to the frame and having a fixed orientation with respect to the frame, the third element being connected to the effector and having a fixed orientation with respect to the effector, and the second element being hinged to the first element and to the third element by two connections each comprising at least two intersecting axes of rotation, said at least one deformable parallelogram device and said at least one transmitting device being able to restrict the movement of the effector to the only three translational degrees of freedom.

2. The serial carrier according to claim 1, wherein the deformable parallelogram passive device is a corner plate device comprising an arm and a reaction bar which are parallel and connected by two connecting rods by pivot connections, one of the connecting rods having the shape of a corner plate to which the second element is hinged.

3. The serial carrier according to claim 1, wherein the deformable parallelogram passive device is a cable link device.

4. The serial carrier according to claim 1, wherein said passive transmitting device is of a fixed length and forms a parallelogram deformable in space with an arm of the deformable parallelogram passive device and wherein at least one of the connections, that said at least one transmitting device comprises, connecting the second element to the first element and to the third element, is a ball-joint connection.

5. The serial carrier according to claim 1, wherein the passive transmitting device is a double U-joint.

6. The serial carrier according to claim 5, wherein the double U-joint has a variable length.

7. The serial carrier according to claim 1, wherein the third connection is a rotoid connection having an axis parallel to that of one of both other connections, comprising a second parallelogram device deformable in the plane, provided between the first deformable parallelogram device and the effector.

8. The serial carrier according to claim 7, wherein the deformable parallelogram passive device is a corner plate device comprising an arm and a reaction bar which are parallel and connected by two connecting rods by pivot connections, one of the connecting rods having the shape of a corner plate to which the second element is hinged and wherein the second parallelogram device deformable in the plane is a corner plate system the corner plate of which is common to the first corner plate device, the second corner plate device connecting the first corner plate device to the effector, the first and second corner plate devices being hinged to the corner plate, said carrier also comprising a second transmitting device connecting the first transmitting device to the effector, both transmitting devices being connected by an element hinged by a pivot connection with respect to said corner plate.

9. The carrier according to claim 8, wherein the second transmitting device is a double U-joint.

10. The carrier according to claim 1, wherein the third connection is a prismatic connection having an axis and wherein the planar deformable parallelogram device is a cable and tackle block device.
